(19) United States
(12) Patent Application Publication
(10) Pub. No.: US 2003/0093544 A1
(43) Pub. Date: May 15, 2003

(54) ATM video caching system for efficient bandwidth usage for video on demand applications

(76) Inventor: John William Richardson, Indianapolis, IN (US)

Correspondence Address: JOSEPH S. TRIPOLI, THOMAS MULTIMEDIA LICENSING INC., 2 INDEPENDENCE WAY, P.O. BOX 5312, PRINCETON, NJ, 08543-5312, US

(21) Appl. No.: 09/993,117

(22) Filed: Nov. 14, 2001

(51) Int. Cl. G06F 15/16

(52) U.S. Cl. 709/231; 725/87

(57) ABSTRACT

An asynchronous transfer mode (ATM) on-demand digital document delivery system and method are disclosed. The system includes a customer interface unit configured to permit a customer to order and receive a digital document on-demand. A server is provided which includes digital documents stored thereon for delivery to customers through a switched ATM network. A cache is coupled to the server for storing digital documents sent by the server when ordered by a customer. The cache reduces network traffic by satisfying the on-demand orders instead of the server.

### FIELD OF THE INVENTION

The present invention generally relates to network communications and, more particularly, to an asynchronous transfer mode (ATM) video caching system and method for efficient bandwidth usage in digital subscriber line (DSL) video-on-demand applications.

### BACKGROUND OF THE INVENTION

Video on demand (VoD) is an emerging technology for home entertainment service businesses. A VoD service permits a customer to request a video in real-time from a large collection of videos stored on a server located in a remote facility. Video transfer can be provided over a network system, such as a telephone system or a cable network, for example. A sufficient amount of bandwidth must be available however to continuously transfer the data from the storage system to the customer's equipment. The amount of bandwidth between a video server and the customer's equipment ultimately determines the maximum number of simultaneous video streams the server can support at any given time.

One key communication transmission technology that is enabling transformation of existing public information networks to accommodate higher bandwidth needs is Asymmetric Digital Subscriber Line (ADSL), a modem technology. ADSL converts existing twisted-pair telephone lines into access paths for multimedia and high-speed data communications. ADSL rates expand existing access capacity by a factor of, say, 50 or more without new cable installations.

Asymmetric Digital Subscriber Line ADSL technology involves modems attached across twisted pair copper wiring in which higher transmission rates can be achieved. Asynchronous transfer mode (ATM) is an ultra high-speed cell based data transmission protocol that may be run over ADSL. A Digital Subscriber Line Access Multiplexer (DSLAM) is a device that takes a number of ADSL subscriber lines and concentrates them to a single ATM line. Plain old telephone service POTS refers to basic analog telephone service. Any server sharing a line with POTS must either use frequencies above POTS or convert POTS to digital and interleave with other data signals.

Currently, there is not an effective solution for guaranteeing adequate bandwidth transmission for the support of real-time video between consumers. Solutions that exist today are based upon leased lines, ISDN, or make use of the Internet. The fixed nature of the leased-line link provides a guaranteed amount of fixed bandwidth between the two end-points. Also, because the leased-line is physically fixed, it does not allow flexible connecting to another premise. This is because the line is physically fixed. The ISDN method has the disadvantages of higher cost, multiple connections for higher bandwidth, and a lack of flexibility for dynamically allocating the bandwidth. The third method, a packet-based network such as the Internet is disadvantageous because the Internet is designed as a best-effort service model. With the Internet, it is nearly impossible to guarantee any specific amount of bandwidth or to put a bound on end-to-end delay variation for any particular service or application. For example, video and e-mail are both treated with the same importance. Even though video is time and jitter sensitive, the Internet does not distinguish between these two different types of traffic. Time and jitter sensitive information, such as video, has much more stringent transmission requirements than that of e-mail. Several initiatives to change the Internet from being a best effort network to one that can differentiate between the multiple types of traffic have failed and are not likely to become a reality in the immediate future. Currently, it is nearly impossible to offer guaranteed bandwidth for transmission of real-time video between consumers. The Internet is also problematic in that it simply does not have the capacity for a large rollout of a point-to-point streaming type service.

Although DSL or ADSL increase bandwidth of conventional twisted pair lines, available bandwidth is still limited. This limitation sets limitations on the amount of data or the number of customers, which are permitted to request a video on demand at any given time in for a video-on-demand service.

Therefore, a need exists for a system and method, which increases the capability of existing network hardware to provide more versatility and efficiency for high data rate transfer. A further need exists for increased bandwidth on existing network hardware to provide improved video on demand capabilities.

### SUMMARY OF THE INVENTION

In accordance with the present invention, an asynchronous transfer mode (ATM) on-demand digital document delivery system and method are disclosed. The system includes a customer interface unit configured to permit a customer to order and receive a digital document on-demand. A server is provided which includes digital documents stored thereon for delivery to customers through a switched ATM network. A cache is coupled to the server for storing digital documents sent by the server when ordered by a customer. The cache reduces network traffic by satisfying the on-demand orders instead of the server.

A method for providing a digital document on-demand, in accordance with the present invention, includes processing a customer request for a digital document received by a server through to a switched network. Then, it is determined whether the digital document is available in a cache system coupled to the switched network. If the digital document is available on the cache system, the customer request is satisfied from the cache system. Otherwise, the customer request is satisfied from the server.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is an exemplary digital subscriber line (DSL) system architecture showing a video server and cache system for providing digital document ondemand service in accordance with the present invention;

FIG. 2 is a block diagram of an illustrative process flow for ordering documents in accordance with the present invention; and

FIG. 3 is a block diagram of an illustrative process flow for controlling content flow of a digital document transferred to a customer location in accordance with the present invention.

It should be understood that the drawings are for purposes of illustrating the concepts of the invention and are not necessarily the only possible configuration for illustrating the invention.

### DETAILED DESCRIPTION OF THE INVENTION

The present invention includes a cache system and method, which can be employed to permit more customers to request video-on-demand (or similar services) while connected to a limited bandwidth network. The present invention advantageously stores the videos most frequently requested by customers in the video cache. The video cache fundamentally reduces the traffic on the network between the video server and the customer. In a digital subscriber line (DSL) architecture, traffic over a network between a server or storage facility device and customer premise equipment, for example, is significantly reduced by employing the cache system of the present invention. By reducing the traffic on the network, the amount of bandwidth required in the network is reduced. This can save money for the service provider (e.g., head-end network provider, such as a competitive local exchange carrier or CLEC) by reducing the costs of the network link, which in effect can also make the video-on-demand service more affordable to the customer.

It is to be understood that the present invention is described in terms of a video-on-demand (VoD) system; however, the present invention is much broader and may include any digital multimedia documents, which are capable of delivery over a switched network. In addition, the present invention is applicable to any system ordering method including orders taken by telephone, set top boxes, computer, satellite links, etc. The present invention is described in terms of a DSL network; however, the concepts of the present invention may be extended to cable, wireless or other network types using ATM technology.

It should be understood that the elements shown in the FIGS. may be implemented in various forms of hardware, software or combinations thereof. Preferably, these elements are implemented in hardware on one or more appropriately programmed general-purpose devices, which may include a processor, memory and input/output interfaces.

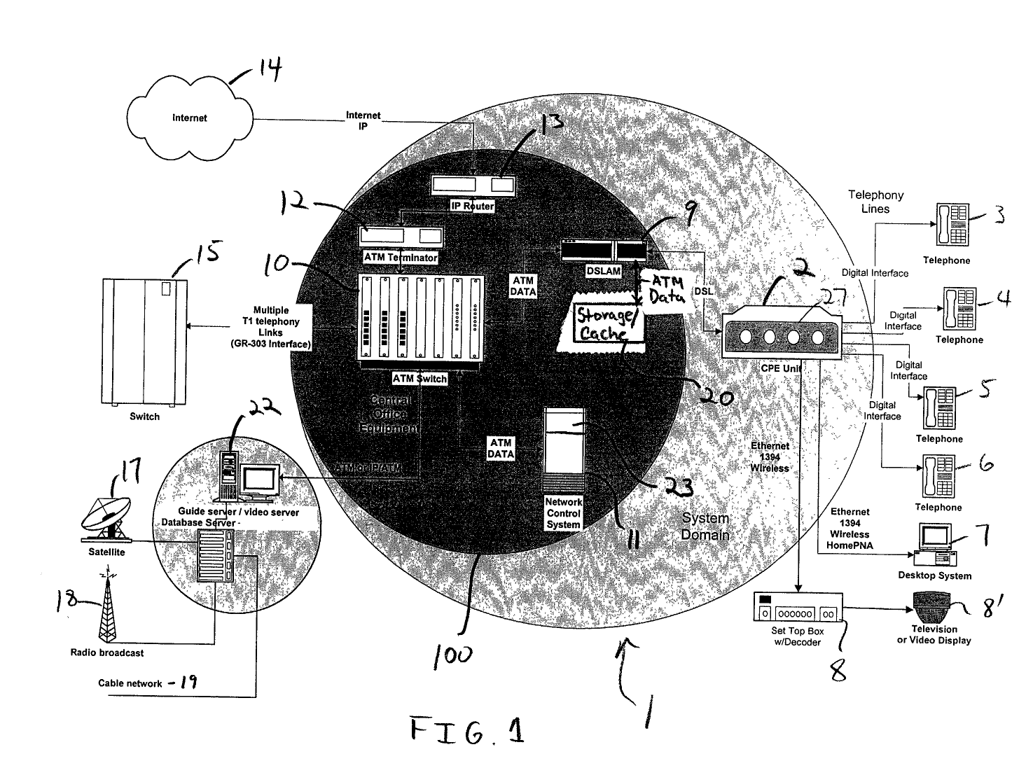

Referring now in specific detail to the drawings in which like reference numerals identify similar or identical elements throughout the several views, and initially to FIG. 1, a DSL system architecture 1 for integrating voice, data and video services is shown in an exemplary DSL environment for employing the present invention. The system block diagram 1 is composed of several functional blocks. The system domain is composed of Central Office (CO) Equipment 100 and Customer Premise Equipment (CPE) 2. The component blocks within the system domain and their respective interfaces are: customer premise equipment (CPE) 2, Digital Subscriber Line Access Multiplexer (DSLAM) 9, an ATM switch 10 and an internet protocol (IP) router 13 and ATM terminator 12. The ATM switch 10 is shown coupled to a program guide server/video server 22 to satellite 17, radio broadcast 18 or cable 19 networks. The ATM switch 10 is also coupled over the DSL terminator 12 and IP router 13 pair to receive Internet Protocol IP packet data from the Internet 14.

The current customer premise equipment (CPE) 2 includes a DSL modem unit 27 that interfaces with separate analog telephones 3-5 over a plain old telephone service (POTS), a 10Base-T Ethernet connection to a PC desktop system 7, and an Ethernet or RS-422 connection to a set-top box with a decoder 8 for connection to a television or video display 8′. From the customer's analog end, the CPE device 2 accepts the analog input from each of the telephones 3-5, converts the analog input to digital data, and packages the data into ATM packets (POTS over ATM), with each connection having a unique virtual channel identifier/virtual path identifier (VPI/VCI). Known to skilled artisans, ATM is a connection-oriented protocol, and, as such, there is a connection identifier in every cell header, which explicitly associates a cell with a given virtual channel on a physical link. The connection identifier includes two sub-fields, the virtual channel identifier (VCI) and the virtual path identifier (VPI). Together these identifiers are used at multiplexing, demultiplexing and switching a cell through the network. VCIs and VPIs are not addresses, but are explicitly assigned at each segment link between ATM nodes of a connection when a connection is established, and remain for the duration of the connection. When using the VCI/VPI, the ATM layer can asynchronously interleave (multiplex) cells from multiple connections.

The Ethernet data is also encapsulated into ATM cells with a unique VCI/VPI. The ATM cell stream is sent to the DSL modem of the CPE unit 2 to be modulated and delivered to the DSLAM unit 9. Going in the other direction, the DSL signal is received and demodulated by the DSL modem 27 in the customer premise equipment 2 and delivered to VPI/VCI detection processing. The ATM cell data with VPI/VCI matching that of the end user's telephone is then extracted and converted to analog POTS to be delivered to the telephone. The ATM cell data with VPI/VCI matching that of the end user's Ethernet is extracted and delivered to an Ethernet transceiver for delivery to the port.

The Digital Subscriber Line Access Multiplexer (DSLAM) 9 demodulates data from multiple DSL modems and concentrates the data onto the ATM backbone network for connection to the rest of the network. DSLAM 9 provides back-haul services for package, cell, and/or circuit based applications through concentration of the DSL lines onto ATM outputs to the ATM switch 10.

The ATM switch 10 is the backbone of the ATM network. The ATM switch 10 performs various functions in the network, including cell transport, multiplexing and concentration, traffic control and ATM-layer management. Of particular interest in the system domain 1, the ATM switch provides for the cell routing and buffering in connection to the DSLAM 9 and the Internet gateway (Internet Protocol IP router 13 and DSL or ATM terminator 12), and T1 circuit emulation support in connection with the multiple telephony links switch 15. The ATM switch 10 may be coupled to a program guide server/video server 22 to connect and interface with satellite, radio broadcast or cable networks. The ATM switch 10 is also coupled over the ATM terminator 12 and IP router 13 pair to receive Internet Protocol IP packet data from the Internet 14.

A video or file cache system 20 interfaces to or can be implemented within, for example, the Digital Subscriber Line Access Multiplexer (DSLAM) 9. Video cache system 20 includes memory, which can be sized in accordance with system needs. Video cache system 20 is preferably compatible with asynchronous transfer mode (ATM) modem technology. Video cache 20 saves copies of documents, such as previously requested video documents, for a predetermined amount of time, for example, for a few hours to perhaps a few weeks.

DSLAM 9 preferably includes a storage mechanism or cache 20 for the purposes of storing more frequently used multimedia/video content and also for serving multimedia/video content to the end-customer across a DSL link. Network control system (NCS) 11 manages the content in the storage mechanism 20 in the DSLAM 9. DSLAM 9 and memory storage in storage mechanism 20 are preferably located at the edge of network 100 (e.g., at or near the boundary between the customer and the network). NCS 11 has a management entity 23 that takes care of pushing content to memory storage 20, and deleting content from storage 20. NCS 11 also provides for the termination point for the signaling that controls the access to the content on storage 20 by setting up and tearing down virtual circuits based on users access rights and requests. In addition, NCS 11 also provides functions for permitting a customer to control the content flow, e.g., functions such as pause, stop, play, advance, reverse, etc. of the content may be controlled by a user in much the same way as traditional VCR functionalities. NCS 11 also provides information on customer activity for billing purposes.

The present invention preferably puts the storage (cache) 20 at the edge of the network (this being within or at the DSLAM 9) to make on-demand content providing services usage more efficient with respect to the network resources. Advantageously, this makes the content distribution a distributed function where it is able to obtain a copy of the content from the nearest location in the network.

NCS 11 (and/or video server 22) is coupled through ATM switch 10 to cache 20 and provides instructions or controls for the amount of time a given video remains in cache 20. In one embodiment, each time a given file or video is requested by a subscriber, an additional amount of time may be added to a timer, and the requested file may be stored in cache for that amount of additional time. In another embodiment, multiple copies of the same video or file may be maintained in cache 20. In this way, popular videos or files can be distributed to subscribers simultaneously to improve access time.

NCS 11 provides for address translation, demand assignment and call management functions. NCS 11 provides functions to manage the DSL/ATM network including the origination and termination of phone calls. NCS 11 is essentially the control entity communicating and translating control information between the class 5 PSTN switch 15 (using e.g., the GR-303 protocol) and the CPE 2. The network control system 11 is available for other functions such as downloading code to the CPE, and bandwidth and call management (e.g., busy) functions, as well as other service provisioning and setting up tasks. NCS 11 may be setup to send videos from video server 22 to DSLAM storage 20 during off-peak times. The videos that are made available can be configured manually by a network administrator or by a script to make the videos transferable over the ATM network. Content (e.g., a movie) will be removed from the DSLAM storage 20, for example, when the demand for a movie reaches a certain low threshold. This threshold may be set automatically or configured as a system parameter.

In one embodiment, NCS 11 is employed to transfer files during windows of low network traffic (e.g., off-peak hours). A schedule may be set up at the NCS 11 to provide for desired transfer times from server 22 to storage 20. When off-peak or desired times are reached, network control system 11 requests video server 22 to start sending the content to the DSLAM storage device 20. The connections are setup in the ATM network (e.g., virtual circuits). NCS 11 includes management entity 23, preferably implemented in software, which pushes content to memory storage 20 and deletes content from storage 20 when appropriate. NCS 11 provides for the termination point for the signaling that controls the access to the content in storage 20 by setting up and tearing down the virtual circuits based on the users access rights and requests. NCS 11 provides the control functions for permitting a customer to control the content flow (e.g., fast forward, reverse, pause, etc.) of cache 20 and video server 22. DSLAM 9 is notified of the incoming content through signaling, and the content is sent from the video server 22 to the DSLAM storage cache 20.

While a video or file is stored in cache 20, if there happens to be another request from a different customer for the same video, the stored cache copy of the video or file will be used, instead of requesting it directly from the video server 22 again. One benefit that cache 20 provides includes that it reduces the traffic on the network and the number of accesses to server 22 that are needed. By reducing the traffic on the network, the amount of bandwidth required in the network is also reduced. This can save money or increase profits for the service provider by reducing the costs of the network link, which in effect can also make the service provided, for example, the video-on-demand service, more affordable to the customer.

It is advantageous for a VoD system to achieve a very low cost method of delivery. One method of delivering video at a low cost is to use multicasting, but it is not possible to apply multicasting in a VoD system. Even if multiple users are watching the same movie multicasting will not work because they will be watching the movie at two different times. For example, one customer may request the movie at 10:00 PM and the other may request the same movie at 10:05 PM. In one case of VoD, two independent copies of the movie are transmitted from a video server to the customers. This requires double the amount of bandwidth. In the case where the video cache is employed in accordance with the present invention, when the first customer requests the video only one copy needs to be sent, and the copy is stored in the cache while the user is simultaneously watching the movie. When the second and third customers request the same movie, the video server checks the cache to see if the movie is there. Cache management software of cache 20 will send a message back notifying the central management system or video server 22 that the video is contained in the cache. The video will then be sent from the video cache 20 instead of from the video server 22.

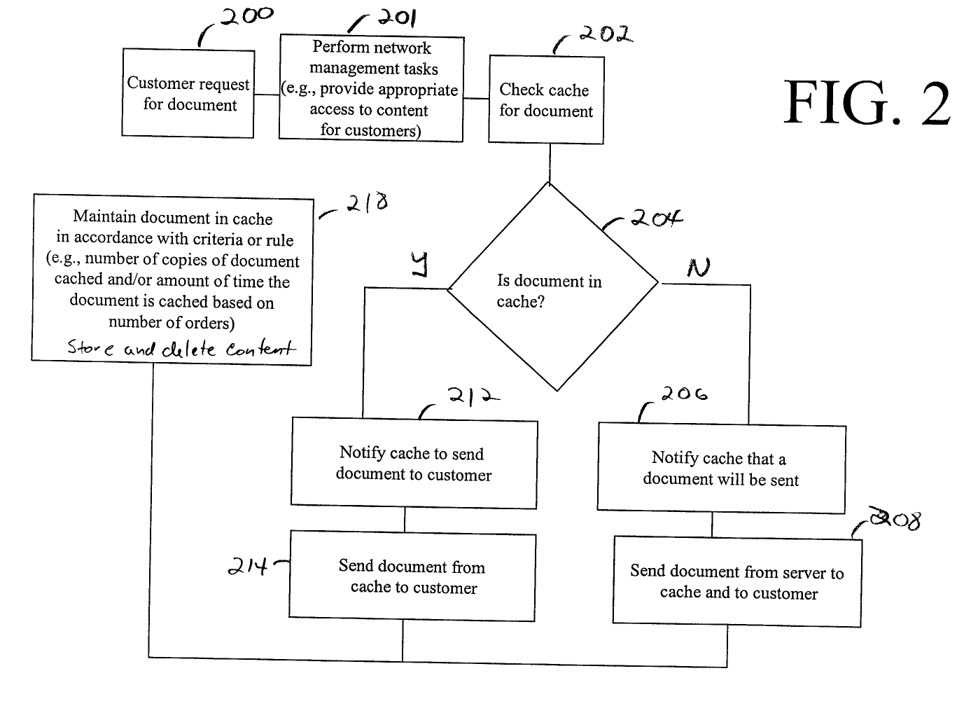

Referring to FIG. 2 with continued reference to FIG. 1, a flow diagram is shown for processing an on-demand document request in an illustrative example of a video-on-demand (VoD) system in accordance with the present invention. In block 200, a request by a customer is made for a digital document, such as a video file. Video requests are preferably generated by customers using a set top box 8, although other devices may be employed (e.g., a telephone). The video request is sent from CPE unit 2, routed by DSLAM 9 through ATM switch (or network) 10 and received by video server 22. In block 201, NCS 11 performs network management functions to (e.g., setting up and tearing down the virtual circuits based on the users access rights and requests) regulate access to the content. In block 202, NCS 11 or video server 22 checks video cache 20 to determine if the requested video is present in cache 20. A determination is made in block 204 as to whether the video is or is not present in video cache 20.

If the video is not in cache 20, cache 20 is notified that the video will be sent from server 22 in block 206. Then, in block 208 the video is sent to and stored in cache 20 and/or to the customer (e.g., to CPE 2). To save time, it is preferable to send the video from server 22 to cache 20 and to the customer concurrently. If the video is in cache 20 already, cache 20 is notified by server 22 to send the video to the customer, in block 212. Then, in block 214, the video is sent to the customer (e.g., to CPE 2).

In block 218, memory storage within video cache 20 is maintained based on predetermined criteria. Information about the number of videos ordered, the clients ordering the videos, pricing and availability are controlled by NCS 11 or server 22. In one example, the frequency of requests is stored and for a given video this information is employed to determine a number of copies of the video that will be stored in the cache. By enabling a greater number of copies of the most popular videos to be made available, access time is further reduced for customers. The amount of time a video remains in cache 20 may also be determined in block 218. This calculation or determination may be made based on the number of orders for a given video. A formula or other criteria may be employed to determine the amount of time a video remains in cache. For example, if no orders for a given video have been placed in a 24-hour period, that video is removed from cache if a video is available to replace it. Other criteria and procedures are also contemplated. NCS 11 maintains the storage on cache 20. This includes storing and deleting content therein.

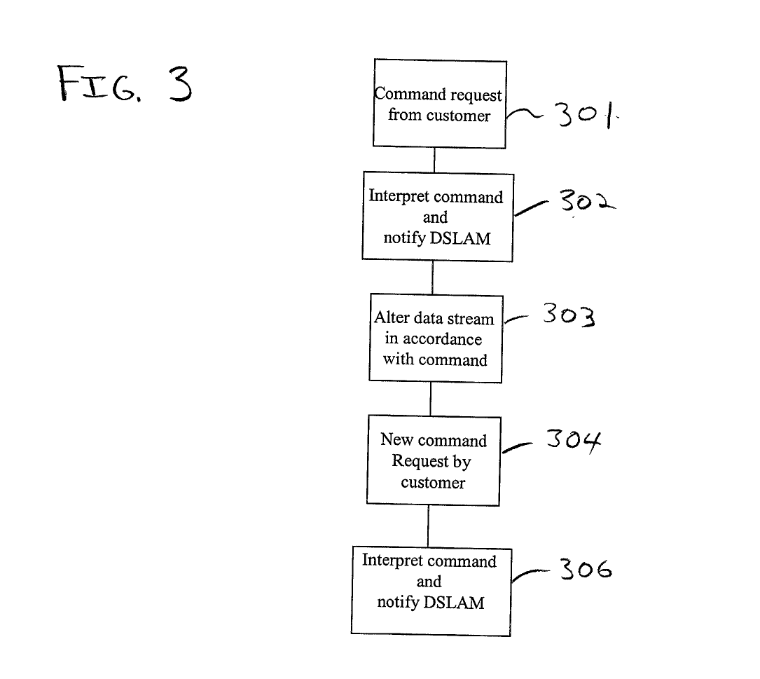

Referring to FIG. 3 with continued reference to FIG. 1, the system of the present invention provides additional functionality and services to the customer. NCS 11 provides for these control functions of cache 20 and video server 22. FIG. 3 shows a flow diagram for controlling the video stream in a way similar to a VCR. For example, if a user requests to pause, stop, fast forward, or rewind the video through set top box interface (remote control) 8, a command request is sent on the ATM virtual circuit signaling channel to NCS 11 in block 301. In block 302, NCS 11 interprets the command and sends a message to DSLAM 9 to notify that a particular user has requested to alter the program stream. In block 303, DSLAM 9 alters the streaming of the data out of the interface (e.g., pausing, fast forwarding, rewinding, etc.). For a pause command, DSLAM 9 records the index position of the program. In block 304, the program is altered until the user provides a new request. The user can, for example, cancel the command through the set top box interface 8. The cancel request is sent on the ATM virtual circuit-signaling channel to the NCS 11. NCS 11 interprets the command and sends a message to DSLAM 9 to notify that the user has requested to cancel the command and resume the normal program stream in block 306. DSLAM 9 continues to stream the data out the interface.

For reversing or rewinding, the DSLAM 9 processes this request and starts indexing the major frame types and sends them out in a decreasing/backwards order (until, for example, the user sends a cancel or stop command) and the DSLAM 9 resumes the video at normal speed from the index of where the reverse was stopped at. Fast forwarding works in a similar way.

Having described preferred embodiments for ATM video caching system for efficient bandwidth usage for video on demand applications (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

We claim:

1. An asynchronous transfer mode (ATM) on-demand digital document delivery system, comprising:
a customer interface unit configured to permit a customer to order and receive a digital document on-demand;
a server having digital documents stored thereon for delivery to customers through a switched ATM network; and
a cache coupled to the server for storing digital documents sent by the server when ordered by a customer, the cache for reducing network traffic by satisfying the on-demand orders instead of the server.

2. The document delivery system, as recited in claim 1, wherein the customer interface unit includes a customer premise unit, which supports digital subscriber line (DSL) technology.

3. The document delivery system, as recited in claim 1, wherein the customer interface unit permits customer orders to be placed by a telephone interface.

4. The document delivery system, as recited in claim 1, further comprising a network control system coupled to the server for checking the cache to determine if the digital document requested by a customer is stored in the cache.

5. The document delivery system, as recited in claim 1, wherein the server is configured to deliver the document to the cache and to the customer concurrently.

6. The document delivery system, as recited in claim 1, further comprising a network control system coupled to the server for determining an amount of time a given document is maintained in the cache.

7. The document delivery system, as recited in claim 6, wherein the amount of time the given document is maintained in the cache is based on a number of orders placed for the given document.

8. The document delivery system, as recited in claim 1, further comprising a multiplexer for routing signals on a DSL link, the multiplexer including the cache.

9. The document delivery system, as recited in claim 8, wherein the cache is located within the switched ATM network at an edge thereof such that content stored in the cache is obtained from a closest point within the switched ATM network to the customer interface unit.

10. The document delivery system, as recited in claim 1, further comprising a network control system coupled to the server, the network control system managing content stored in the cache.

11. The document delivery system, as recited in claim 1, wherein the documents are videos and the delivery system is a video-on-demand (VoD) delivery system.

12. The document delivery system, as recited in claim 11, wherein the customer interface unit is coupled to a customer control device such that the customer controls a data stream of the video being delivered to the customer by remotely signaling a network control system.

13. The document delivery system, as recited in claim 1, further comprising a network control system coupled to the customer interface unit and the cache to control access to content stored in the cache or on the server by customers.

14. The document delivery system, as recited in claim 13, further comprising virtual circuits set up by the network control system to control access to content stored in the cache or on the server by customers.

15. A method for providing a digital document on-demand over an asynchronous transfer mode (ATM) network, comprising the steps of:
processing a customer request for a digital document received by a server through to a switched ATM network;
storing the digital document in a cache located within the ATM network;
determining whether the digital document is available in a cache system coupled to the ATM network;
if the digital document is available on the cache system, satisfying the customer request from the cache system; and
otherwise, satisfying the customer request from the server.

16. The method as recited in claim 15, wherein the step of satisfying the customer request from the server further comprises the step of sending a copy of the digital document to the cache system for storage.

17. The method as recited in claim 15, further comprising the steps of:
determining a number of customer orders for a given digital document over the ATM network; and
providing an amount of time during which the given digital document is stored cache in accordance with the number of customer orders.

18. The method as recited in claim 15, further comprising the steps of:
determining a number of customer orders for a given digital document over the ATM network; and
providing a number of copies of the given digital document to be stored cache in accordance with the number of customer orders.

19. The method as recited in claim 15, wherein the customer request is originated from customer premise equipment, which employs a digital subscriber line.

20. The method as recited in claim 15, wherein the digital document includes a video file.

21. The method as recited in claim 15, further comprising the step of managing access to content of the cache system and the server based on user access rights and requests.

22. The method as recited in claim 15, wherein the digital documents include videos and further comprising the step of controlling content flow of a data stream of a video from a customer location.

23. The method as recited in claim 15, wherein the content flow is controlled by one of reversing, fast forwarding or pausing the video.

24. The method as recited in claim 15, wherein the ATM network includes a network control system, the method further comprising the steps of managing content on the cache system by pushing content to the cache system and deleting content from the cache system.
